(19) United States
(12) Patent Application Publication
(10) Pub. No.: US 2014/0228166 A1
(43) Pub. Date: Aug. 14, 2014

(54) METHOD AND APPARATUS FOR CONTROLLING MOTOR TORQUES IN A MULTI-MODE POWERTRAIN SYSTEM

(71) Applicant: GM GLOBAL TECHNOLOGY OPERATIONS LLC, Detroit, MI (US)

(72) Inventors: ANTHONY H. HEAP, ANN ARBOR, MI (US); SEAN W. MCGROGAN, ANN ARBOR, MI (US)

(73) Assignee: GM GLOBAL TECHNOLOGY OPERATIONS LLC, Detroit, MI (US)

(21) Appl. No.: 13/765,028

(22) Filed: Feb. 12, 2013

(51) Int. Cl. B60W 20/00

(52) U.S. Cl. CPC B60W 20/00
USPC 477/5; 180/65.265; 903/902

(57) ABSTRACT

A powertrain system includes an engine and a multi-mode transmission configured to transfer torque among the engine, first and second torque machines, and an output member. The input member includes a clutch element configured to prevent rotation of the engine in a first direction. In response to an output torque request when the engine is in an OFF state, the motor torques from the first and second torque machines are controlled in response to the output torque request including controlling the motor torque from the first torque machine at a positive torque greater than a minimum positive torque and controlling the motor torque from the second torque machine responsive to the output torque request and responsive to the motor torque from the first torque machine.

### TECHNICAL FIELD

This disclosure is related to dynamic system controls for multi-mode powertrain systems employing multiple torque-generative devices.

### BACKGROUND

The statements in this section merely provide background information related to the present disclosure. Accordingly, such statements are not intended to constitute an admission of prior art.

Powertrain systems may be configured to transfer torque originating from multiple torque actuators through a torque transmission device to an output member that can be coupled to a driveline. Such powertrain systems include hybrid powertrain systems and extended-range electric vehicle systems. Control systems for operating such powertrain systems operate the torque actuators and apply torque transfer elements in the transmission to transfer torque in response to operator-commanded output torque requests, taking into account fuel economy, emissions, driveability, and other factors. Exemplary torque actuators include internal combustion engines and non-combustion torque machines. The non-combustion torque machines may include electric machines that are operative as motors or generators to generate a torque input to the transmission in conjunction with or independently of a torque input from the internal combustion engine. The torque machines may transform vehicle kinetic energy transferred through the vehicle driveline to electrical energy that is storable in an electrical energy storage device in a regenerative operation. A control system monitors various inputs from the vehicle and the operator and provides operational control of the hybrid powertrain, including controlling transmission operating range and gear shifting, controlling the torque actuators, and regulating the electrical power interchange among the electrical energy storage device and the torque actuators to manage outputs of the transmission, including torque and rotational speed.

Known multi-mode electrically-variable transmissions (EVTs) can be configured to operate in one or more fixed-gear ranges, one or more electric vehicle (EV) ranges, one or more electrically-variable transmission (EVT) ranges, and one or more neutral ranges. A zero torque output from one of the torque machines may be desirable while operating in one of the transmission ranges due to a commanded neutral condition, in response to a derated torque output of the torque machine, and in response to a fault associated with operation of the torque machine.

### SUMMARY

A powertrain system includes an engine and a multi-mode transmission configured to transfer torque among the engine, first and second torque machines, and an output member. The input member includes a clutch element configured to prevent rotation of the engine in a first direction. In response to an output torque request when the engine is in an OFF state, the motor torques from the first and second torque machines are controlled in response to the output torque request including controlling the motor torque from the first torque machine at a positive torque greater than a minimum positive torque and controlling the motor torque from the second torque machine responsive to the output torque request and responsive to the motor torque from the first torque machine.

### BRIEF DESCRIPTION OF THE DRAWINGS

One or more embodiments will now be described, by way of example, with reference to the accompanying drawings, in which:

FIG. 1 illustrates a multi-mode powertrain system including an internal combustion engine and a multi-mode transmission, in accordance with the disclosure;

FIG. 2 illustrates operating parameters associated with the powertrain system described with reference to FIG. 1 executing the control scheme described with reference to FIG. 3, in accordance with the disclosure; and

FIG. 3 illustrates a control scheme employed to control the powertrain system described with reference to FIG. 1, in accordance with the disclosure.

### DETAILED DESCRIPTION

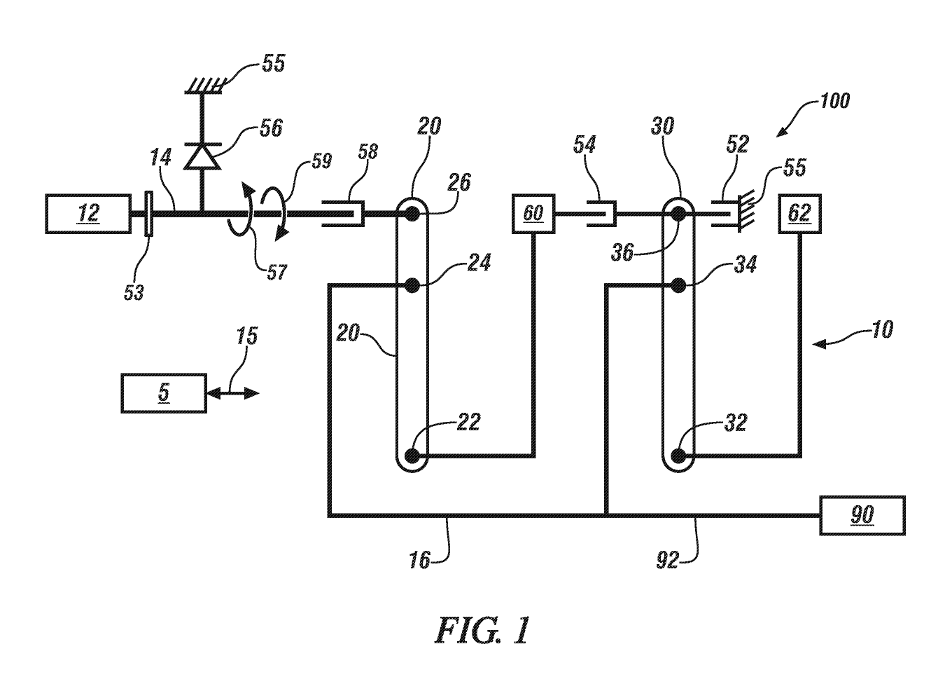

Referring now to the drawings, wherein the showings are for the purpose of illustrating certain exemplary embodiments only and not for the purpose of limiting the same, FIG. 1 depicts a non-limiting multi-mode powertrain system 100 including an internal combustion engine (engine) 12, a multi-mode transmission (transmission) 10 that couples to a high-voltage electrical system, and a controller 5. The transmission 10 mechanically couples to torque actuators including the engine 12 and first and second torque machines 60 and 62, respectively, and is configured to transfer torque between the engine 12, the first and second torque machines 60, 62, and a driveline 90. As illustrated, the first and second torque machines 60, 62 are electric motor/generators. The driveline 90 can include a differential system that facilitates a rear-wheel drive vehicle configuration or a transaxle system that facilitates a front-wheel drive vehicle configuration.

The engine 12 may be any suitable combustion device, and includes a multi-cylinder internal combustion engine selectively operative in several states to transfer torque to the transmission 10 via an input member 14, and can be either a spark-ignition or a compression-ignition engine. The engine 12 preferably includes a crankshaft coupled to the input member 14 of the transmission 10. Power output from the engine 12, i.e., engine speed and engine torque, can differ from input speed and input torque to the transmission 10 due to placement of torque-consuming components on the input member 14 between the engine 12 and the transmission 10, e.g., a mechanically-powered hydraulic pump. The engine 12 is configured to execute autostop and autostart operations in response to operating conditions, thus causing the engine 12 to be in one of an ON state and an OFF state during ongoing powertrain operation. When the engine operates in the ON state it is fueled, firing, and spinning. When the engine is controlled to the OFF state, it is unfueled, not firing, and is not spinning. The controller 5 is configured to control actuators of the engine 12 to control combustion parameters including intake mass airflow, spark-ignition timing, injected fuel mass, fuel injection timing, EGR valve position to control flow of recirculated exhaust gases, and intake and/or exhaust valve timing and phasing on engines so equipped. The engine 12 employs fast engine actuators, e.g., spark timing control or fuel injection timing control, and slow engine actuators, e.g., throttle/mass air control or fuel mass control, to control engine torque output. Hence, engine speed and torque can be controlled by controlling combustion parameters including airflow torque and spark induced torque. Engine speed may also be controlled by controlling reaction torque at the input member 14 by controlling motor torques of first and second torque machines 60, 62.

The illustrated transmission 10 is a two-mode, compound-split, electro-mechanical transmission 10 that includes first and second planetary-gear sets 20 and 30, respectively, and two engageable torque-transferring devices, i.e., clutches C1 52 and C2 54, respectively. The two modes of operation refer to power-split modes of operation including an input-split mode and a compound-split mode as described herein. Other embodiments of the transmission 10 are contemplated including those have three or more power-split modes of operation. The transmission 10 is configured to transfer torque between the engine 12, the first and second torque machines 60, 62, and an output member 92 in response to an output torque request. The first and second torque machines 60, 62 are motor/generators that employ electric energy to generate and react torque in one embodiment. The planetary gear set 20 includes a sun gear member 22, a ring gear member 26, and planet gears 24 coupled to a carrier member. The carrier member rotatably supports the planet gears 24 that are disposed in meshing relationship with both the sun gear member 22 and the ring gear member 26, and couples to rotatable shaft member 16. The planetary gear set 30 includes a sun gear member 32, a ring gear member 36, and planet gears 34 coupled to a carrier member. The planet gears 34 are disposed in meshing relationship with both the sun gear member 32 and the ring gear member 36, and the carrier member couples to the rotatable shaft member 16.

The input member 14 includes a one-way clutch device C3 56, a torque damping device 53, e.g., a torque converter, and a torque limiter device including a breakaway clutch 58 that mechanically couples between the input member 14 and a rotating member coupled to an input member of the transmission, shown as the ring gear member 26 of the first planetary gear set 20 in one embodiment.

The one-way clutch C3 56 is a mechanical diode or other suitable device that is arranged to mechanically couple to a transmission case 55 to prevent rotation of the input member 14 and the engine 12 in a first direction 57 when activated. The first direction 57 is a rotational direction associated with the engine spinning in a backwards direction. As configured, the one-way clutch C3 56 prevents engine rotation and torque transfer in the first direction 57 to prevent the engine from rotating and spinning in the backwards direction when the engine is in an OFF state. The one-way clutch C3 56 permits engine rotation and torque transfer in a second direction 59 that is associated with a positive or forward direction of engine rotation that occurs when the engine 12 is in the ON state spinning and generating torque.

When the engine is in an OFF state, the first electric machine 60 may operate as a motor to provide tractive torque to the output member 92 to propel the vehicle. Accordingly, a load applied to the one-way clutch C3 56 in the first direction 57 engages the one-way clutch device 56 to the transmission case 55, preventing the input member 14 from rotating in a first direction. In one embodiment, the first torque machine 60 can provide the load in the first direction to engage the one-way clutch C3 56 while the second torque machine 62 applies a negative load to cancel any output torque resulting from the first torque machine 60 providing the load in the first direction. Rotational torques, loads and speeds in the first direction 57 are negative. Engagement of the one-way clutch C3 56 is provided by engaging elements of the one-way clutch C3 56 that includes, e.g., rollers, sprags, rockers or struts that freely engage one or more cams, notches, recesses, or similar features in the adjacent member, i.e., the transmission case 55 when a load is applied to the one-way clutch C3 56 in the first direction 57. One having ordinary skill in the art recognizes that a number of clutch designs are capable of functioning as a one-way clutch device, and this disclosure is not intended to be limited to particular embodiments described herein. The one-way clutch C3 56 permits rotation of the input member 14 in the second direction 59 opposite to the first direction 57. When the rotational direction of the input member 14, including a rotational speed and torque/load, is in the second direction 59, the one-way clutch device C3 56 is released and disengaged from the transmission case 55. Thus, the input member 14 is ungrounded and free to rotate or freewheel in the second direction 59. In an exemplary embodiment, the input member 14 rotates in the second direction when the engine 12 is applying tractive torque to the transmission 10. Rotational torques, loads and speeds in the second direction 59 are referred to herein as positive. One-way clutch devices are non-hydraulic and only have a torque transfer capacity in one direction, e.g., the first direction 57. A reactive load can be applied to maintain the one-way clutch C3 56 in an activated state.

The C1 52 and C2 54 clutches refer to torque transfer devices that can be selectively applied in response to a control signal. The C1 52 and C2 54 clutches may be any suitable torque transfer device including by way of example a single or compound plate clutch or pack, a one-way clutch, and a band clutch. A control circuit is configured to control clutch states of each of the clutches, including individually activating and deactivating the C1 5 and C2 54 clutches. In one embodiment, the control circuit is a hydraulic circuit configured to control pressurized hydraulic fluid supplied by a hydraulic pump that can be operatively controlled by the controller 5. Clutch C2 54 is a rotating clutch and clutch C1 52 is a brake device that can ground to the transmission case 55.

A high-voltage electrical system includes an electrical energy storage device, e.g., a high-voltage battery (battery) electrically coupled to an inverter module via a high-voltage electrical bus, and is configured with suitable devices for monitoring electric power flow including devices and systems for monitoring electric current and voltage. The battery can be any suitable high-voltage electrical energy storage device, e.g., a high-voltage battery, and preferably includes a monitoring system that measures electrical power supplied to the high-voltage electrical bus, including voltage and current.

The first and second torque machines 60, 62 are three-phase AC motor/generator machines in one embodiment with each including a stator, a rotor, and a rotational speed sensor, e.g., a resolver. The motor stator for each of the torque machines 60, 62 is grounded to an outer portion of the transmission case 55, and includes a stator core with coiled electrical windings extending therefrom. The rotor for the first torque machine 60 is supported on a hub plate gear that mechanically attaches a rotating member that couples to the sun gear 22 of the first planetary gear set 20. The rotor for the second torque machine 62 is fixedly attached to a rotating member that couples to the sun gear 32 of the second planetary gear set 30.

The output member 92 of the transmission 10 rotatably connects to the driveline 90 to provide output power to the driveline 90 that is transferred to one or a plurality of vehicle wheels via differential gearing, a transaxle, or another suitable device. The output power at the output member 92 is characterized in terms of an output rotational speed and an output torque.

The input torque from the engine 12 and the motor torques from the first and second torque machines 60, 62 are generated as a result of energy conversion from fuel or electrical potential stored in the battery. The battery is high voltage DC-coupled to the inverter module via the high-voltage electrical bus. The inverter module preferably includes a pair of power inverters and respective motor control modules configured to receive torque commands and control inverter states therefrom for providing motor drive or regeneration functionality to meet the motor torque commands. The power inverters include complementary three-phase power electronics devices, and each includes a plurality of insulated gate bipolar transistors (IGBTs) for converting DC power from the battery to AC power for powering respective ones of the first and second torque machines 60 and 62, by switching at high frequencies. The IGBTs form a switch mode power supply configured to receive control commands. Each phase of each of the three-phase electric machines includes a pair of IGBTs. States of the IGBTs are controlled to provide motor drive mechanical power generation or electric power regeneration functionality. The three-phase inverters receive or supply DC electric power via DC transfer conductors and transform it to or from three-phase AC power, which is conducted to or from the first and second torque machines 60 and 62 for operation as motors or generators via transfer conductors. The inverter module transfers electrical power to and from the first and second torque machines 60 and 62 through the power inverters and respective motor control modules in response to the motor torque commands. Electrical current is transmitted across the high-voltage electrical bus to and from the battery to charge and discharge the high-voltage battery.

The controller 5 signally and operatively links to various actuators and sensors in the powertrain system 100 via a communications link 15 to monitor and control operation of the powertrain system 100, including synthesizing information and inputs, and executing algorithms to control actuators to meet control objectives related to fuel economy, emissions, performance, drivability, and protection of hardware, including cells of the high-voltage battery and the first and second torque machines 60 and 62. The controller 5 is a subset of an overall vehicle control architecture, and provides coordinated system control of the powertrain system. The controller 5 may include a distributed control module system that includes individual control modules including a supervisory control module, an engine control module, a transmission control module, a battery pack control module, and the inverter module. A user interface is preferably signally connected to a plurality of devices through which a vehicle operator directs and commands operation of the powertrain system, including commanding an output torque request and selecting a transmission range. The devices preferably include an accelerator pedal, an operator brake pedal, a transmission range selector (PRNDL), and a vehicle speed cruise control system. The transmission range selector may have a discrete number of operator-selectable positions, including indicating direction of operator-intended motion of the vehicle, and thus indicating the preferred rotational direction of the output member 92 of either a forward or a reverse direction. It is appreciated that the vehicle may still move in a direction other than the indicated direction of operator-intended motion due to rollback caused by location of a vehicle, e.g., on a hill. The operator-selectable positions of the transmission range selector can correspond directly to individual transmission ranges described with reference to Table 1, or may correspond to subsets of the transmission ranges described with reference to Table 1. The user interface may include a single device, as shown, or alternatively may include a plurality of user interface devices directly connected to individual control modules.

The aforementioned control modules communicate with other control modules, sensors, and actuators via the communications link 15, which effects structured communication between the various control modules. The communication protocol is application-specific. The communications link 15 and appropriate protocols provide for robust messaging and multi-control module interfacing between the aforementioned control modules and other control modules providing functionality including e.g., antilock braking, traction control, and vehicle stability. Multiple communications buses may be used to improve communications speed and provide some level of signal redundancy and integrity, and may include direct links and serial peripheral interface (SPI) buses. Communication between individual control modules may also be effected using a wireless link, e.g., a short range wireless radio communications bus. Individual devices may also be directly connected.

Control module, module, control, controller, control unit, processor and similar terms mean any one or various combinations of one or more of Application Specific Integrated Circuit(s) (ASIC), electronic circuit(s), central processing unit(s) (preferably microprocessor(s)) and associated memory and storage (read only, programmable read only, random access, hard drive, etc.) executing one or more software or firmware programs or routines, combinational logic circuit(s), input/output circuit(s) and devices, appropriate signal conditioning and buffer circuitry, and other components to provide the described functionality. Software, firmware, programs, instructions, routines, code, algorithms and similar terms mean any instruction sets including calibrations and look-up tables. The control module has a set of control routines executed to provide the desired functions. Routines are executed, such as by a central processing unit, to monitor inputs from sensing devices and other networked control modules and execute control and diagnostic routines to control operation of actuators. Routines may be executed at regular intervals referred to as loop cycles, for example each 3.125, 6.25, 12.5, and 100 milliseconds during ongoing powertrain operation. Alternatively, routines may be executed in response to occurrence of an event.

The powertrain system 100 is configured to operate in one of a plurality of powertrain states, including a plurality of transmission ranges and engine states to generate and transfer torque to the driveline 90. The engine states include the ON state, the OFF state, and a fuel cutoff (FCO) state. When the engine operates in the FCO state, it is spinning but is unfueled and not firing. The engine ON state may further include an all-cylinder state (ALL) wherein all cylinders are fueled and firing, and a cylinder-deactivation state (DEAC) wherein a portion of the cylinders are fueled and firing and the remaining cylinders are unfueled and not firing. The transmission ranges include a plurality of neutral (Neutral), fixed gear (Gear #), electric vehicle (EV#), and electrically-variable mode (EVT Mode #) ranges that are achieved by selectively activating the clutches C1 52 and C2 54. The Neutral range includes an electric torque converter (ETC) range, during which electric power can flow to or from the battery in relation to the output torque, the engine speed, the output speed, and speed of one of the torque machines, albeit with zero tractive torque output from the torque machines. Other powertrain states, e.g., transitional ranges may be employed. Table 1 depicts a plurality of the powertrain states including transmission ranges and engine states for operating the multi-mode powertrain.

TABLE 1

| Range | Engine State | C1 | C2 |
|---|---|---|---|
| Neutral 1/ETC | ON(ALL/DEAC/FCO)/OFF | | |
| EVT Mode 1 | ON(ALL/DEAC/FCO) | x | |
| EVT Mode 2 | ON(ALL/DEAC/FCO) | | x |
| Fixed Gear 1 | ON(ALL/DEAC/FCO) | x | x |
| 2 motor EV | OFF | x | |
| Motor A EV | OFF | | x |
| Motor B EV | OFF | x | |

The powertrain configuration permits two power split modes of operation when the engine is on, including the input-split mode, e.g., EVT1 and the compound-split mode, e.g., EVT2. The configurations allow the second torque machine 62 to be disconnected from the transmission output member 92 without disrupting the flow of power from the engine 12 and first torque machine 60.

The one-way clutch C3 56 prevents engine rotation and torque transfer in the first direction 57 to prevent the engine from rotating and spinning in a backwards direction when the engine is in an OFF state. The one-way clutch C3 56 permits engine rotation and torque transfer in the second direction 59 that includes a direction of engine rotation when the engine is in the ON state, i.e., is spinning and generating torque. There is a need to prevent engine rotation and torque transfer in the second direction 59 when the engine is in the OFF state during ongoing powertrain operation without employing a clutch, a brake or another mechanical device, preferably while optimally operating the powertrain system in terms of fuel and power consumption.

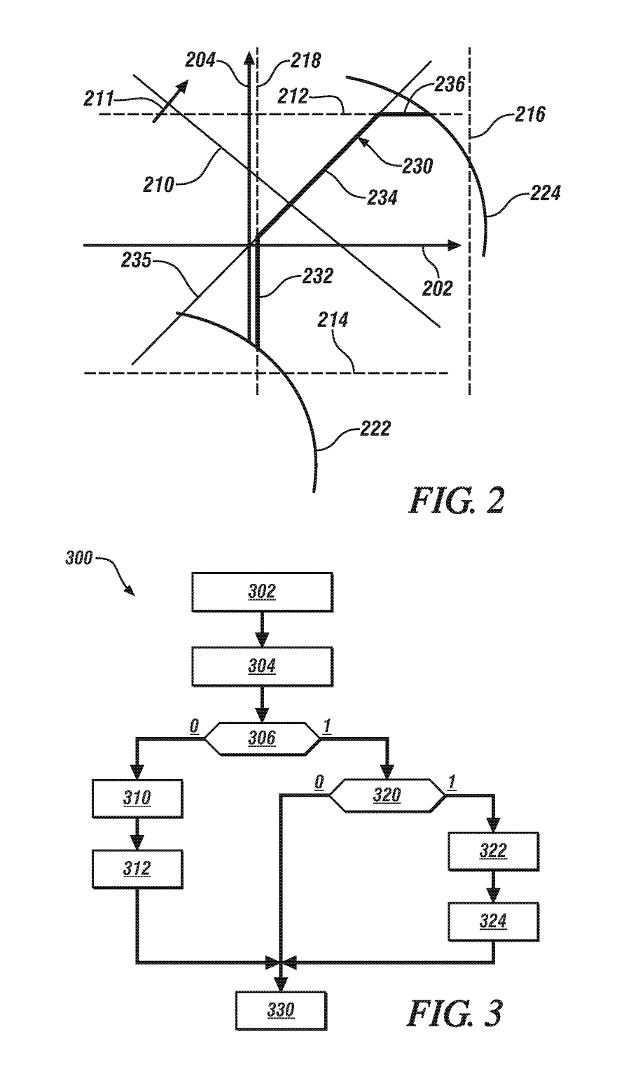

FIG. 2 graphically shows transmission operating parameters associated with operating an embodiment of the powertrain system 100 described with reference to FIG. 1 in one of the EV ranges wherein the engine 12 is in the OFF state and the first and second torque machines 60, 62 generate tractive torque responsive to the output torque request and to prevent engine rotation in the second direction 59, i.e., to prevent engine rotation in the positive direction. The motor torques from the first and second torque machines 60, 62 are referred to herein as motor A torque and motor B torque, respectively. Engine rotation and torque transfer in the second direction 59 can be prevented by applying torque to the input member 14 in the first direction 57, with such applied torque originating from the first torque machine 60. The transmission operating parameters are shown for a single operating point that is representative of operating the embodiment of the powertrain system 100 in one of the EV modes, e.g., with the engine in the OFF state and clutch C1 52 applied, clutch C2 54 deactivated, and the one-way clutch C3 56 applied to prevent rotation of the engine 12 in the first direction 57, i.e., to prevent rotation of the engine 12 in the negative direction.

The motor A torque 202 generated by the first torque machine 60 is shown coincident with the x-axis and the motor B torque 204 generated by the second torque machine 62 is shown coincident with the y-axis. Applied clutch torque limits include minimum and maximum clutch torques 212 and 214 for clutch C1 52, which are determined based upon the torque capacity of the applied clutch in relation to hydraulic pressure. Applied clutch torque limits also include minimum and maximum clutch torques 216 and 218 for the one-way clutch C3 56. The minimum clutch torque 216 for the one-way clutch C3 56 is determined based upon yield strength of the one-way clutch materials. The maximum clutch torque 218 for the one-way clutch C3 56 is a magnitude of torque wherein the clutch elements decouple from each other, and is near zero torque. Minimum and maximum battery powers 222 and 224, respectively, are shown, and are based upon the capacity of the high-voltage battery to charge and discharge, respectively. Output torque 210 is plotted in relation to the aforementioned parameters for the transmission operating as described, with an arrow 211 depicting direction of increasing magnitude of the output torque 210. An optimal motor torque split line 235 depicts optimal magnitudes of motor A torque 202 and motor B torque 204 in relation to the output torque 210. The optimized motor torque commands of the optimal motor torque split line 235 represent magnitudes of motor A torque 202 and motor B torque 204 that minimize mechanical and electrical power losses and most advantageously control operation of the torque machines to achieve the output torque request while operating in the selected EV range, and are determined based upon inverter and motor efficiencies and other system efficiencies.

Line 230, including line segments 232, 234, and 236 depicts preferred magnitudes of motor A torque 202 and motor B torque 204 for operating the powertrain system 100 responsive to the output torque 210 with the engine in the OFF state to prevent engine rotation in the second direction 59, thus maintaining the input speed from the input member at zero speed. Line segment 232 represents that portion of powertrain operation wherein the powertrain system is incapable of operating along the optimal motor torque split line 235 while satisfying the maximum clutch torque 218 for the one-way clutch C3 56 because the output torque 210 is less than the minimum value of the motor B torque 204 that is required to achieve the maximum clutch torque 218 for the one-way clutch C3 56, with a minimum value of the motor B torque 204 limited by the minimum battery power 222. Line segment 232 represents the portion of powertrain operation wherein the only way to operate at the desired output torque 210, while satisfying the maximum clutch torque 218 is to depart from the optimal split line 235. During such operation, the motor A torque 202 is controlled to be equal to a magnitude of torque that produces the maximum clutch torque 218 for the one-way clutch C3 56 and the motor B torque 204 is controlled in response and to achieve the output torque request 210. This may result is operation that is sub-optimal from the perspective of power efficiency. However, the engine is prevented from spinning in the second direction 59 when in the OFF state. Line segment 234 coincides with the optimal motor torque split line 235. During such operation, the motor A torque 202 and the motor B torque 204 are controlled in response and to achieve the output torque request 210. As such, the motor A torque 202 is applied to the input member 14 and thus to the one-way clutch C3 56 in the first direction 57 to prevent the engine from spinning in the second direction 59.

Line segment 236 represents that portion of powertrain operation wherein the powertrain system is incapable of operating along the optimal motor torque split line 235 while satisfying the minimum clutch torque 212 for clutch C1 52 because the output torque 210 is greater than the maximum value of the motor A torque 202 that is required to achieve the minimum clutch torque 212 for clutch C1 52 with a maximum value of the motor A torque 202 limited by the maximum battery power 224. Line segment 236 represents the portion of powertrain operation wherein the only way to operate at the desired output torque 210, while satisfying the minimum clutch torque 212 is to depart from the optimal split line 235. During such operation, the motor B torque 204 is controlled to be equal to a magnitude of torque that produces the minimum clutch torque 212 for clutch C1 52 and the motor A torque 202 is controlled in response and to achieve the output torque request 210. This may result in powertrain operation that is sub-optimal from the perspective of power efficiency. However, it has the advantage that the clutch torque constraints are not violated and the motor A torque 202 is applied to the input member 14 and thus to the one-way clutch C3 56 in the first direction 57 to prevent the engine from spinning in the second direction 59 when in the OFF state.

FIG. 3 schematically shows an embodiment of a control scheme 300 that is employed to control an embodiment of the powertrain system 100 described with reference to FIG. 1 in one of the EV ranges wherein the engine is in the OFF state and the first and second torque machines 60, 62 generate tractive torque responsive to the output torque request and to prevent engine rotation in the second direction 59, i.e., to prevent engine rotation in the positive direction. Table 2 is provided as a key to FIG. 3 wherein the numerically labeled blocks and the corresponding functions are set forth as follows.

TABLE 2

| BLOCK | BLOCK CONTENTS |
|---|---|
| 302 | Operate powertrain system in selected EV range |
| 304 | Determine Ta-opt, Tb-opt responsive to To in selected EV |
| | range |
| 306 | Is Ta-opt less than Ta at T_{c12-max}? |
| 310 | Set Ta = Ta at T_{c12-max} |
| 312 | Determine Tb responsive to Ta, To |
| 320 | Does Tb-opt exceed Tb at T_{c11-min}? |
| 322 | Set Tb = Tb at T_{c11-min} |
| 324 | Determine Ta responsive to Tb, To |
| 330 | Control Ta, Tb |

In response to a command to operate in a selected one of the EV ranges, one of the clutches and the one-way clutch device C3 are activated and the engine is controlled in the OFF state (302). By way of example, when the powertrain system operates in the motor B EV range described with reference to Table 1, clutch C1 and the one-way clutch device C3 are activated and the engine is controlled in the OFF state.

The control system calculates preferred torque commands for the first and second torque machines, i.e., Ta-opt and Tb-opt, respectively, that are responsive to an output torque request (304). The preferred torque commands for the first and second torque machines are determined based upon power efficiencies to minimize mechanical and electrical power losses and most advantageously control operation of the torque machines to achieve the output torque request while operating in the selected EV range. A process for determining optimized torque commands is known to skilled practitioners and not described in detail herein.

The preferred torque command for the first torque machine Ta-opt is compared to a torque command for the torque machine at a maximum clutch torque for the one-way clutch C3 (Ta at T_{c12-max}) (306). The operation of the one-way clutch C3 can be characterized in terms of minimum and maximum clutch torques, with the minimum clutch torque (T_{c12-max}) associated with yield strength of the one-way clutch materials. The maximum clutch torque (T_{c12-max}) is associated with a magnitude of torque wherein the clutch elements decouple from each other, and is near zero torque. A control situation that permits operation with a clutch torque greater than the maximum clutch torque (T_{c12-max}) will result in the clutch elements decoupling from each other. In such a situation, the engine is permitted to spin in the second direction 59 associated with positive direction of engine rotation that occurs when the engine is in the ON state, which is an undesirable state.

When the preferred torque command for the first torque machine Ta-opt is less than the torque command for the first torque machine at the maximum clutch torque for the one-way clutch C3 (Ta at T_{c12-max}) (306)(1), the motor A torque command is set equal to the torque command for the first torque machine at the maximum clutch torque (Ta=Ta at T_{c12-max}) (310). Thus, the motor A torque command is controlled at a positive torque that is greater than a minimum positive torque. The motor B torque command is determined as a torque command that achieves the output torque request when the motor A torque command is set equal to the torque command for the first torque machine at the maximum clutch torque (Ta=Ta at T_{c12-max}) (312). The powertrain system is controlled using the calculated motor B torque command with the motor A torque command set equal to the torque command for the torque machine at the maximum clutch torque (Ta=Ta at T_{c12-max}) (330).

When the preferred torque command for the first torque machine Ta-opt is greater than the torque command for the first torque machine at the maximum clutch torque for the one-way clutch C3 (Ta at T_{c12-max}) (306)(0), the optimized torque command for the second torque machine (Tb-opt) is compared to a torque command for the second torque machine at a minimum clutch torque for the first clutch C1 (Tb at T_{c11-min}) (320). When the optimized torque command for the second torque machine (Tb-opt) does not exceed the torque command for the second torque machine at the minimum clutch torque for the first clutch C1 (Tb at T_{c12-min}) (320)(0), the powertrain system is controlled employing the optimized torque commands (Ta-opt, Tb-opt) as the motor A and motor B torque commands (330).

When the optimized torque command for the second torque machine (Tb-opt) exceeds the torque command for the second torque machine at the minimum clutch torque for the first clutch C1 (Tb at T_{c11-min}) (320)(1), the motor B torque command is set equal to the torque command for the second torque machine at the minimum clutch torque (Tb=Tb at T_{c11-min}) (322) and the control scheme calculates the motor A torque command that achieves the output torque request when the motor B torque command is set equal to the torque command for the second torque machine at the minimum clutch torque (Tb=T_{c11-min}) (324). The powertrain system is controlled using the motor A torque command that achieves the output torque request when the motor B torque command is set equal to the torque command for the second torque machine at the minimum clutch torque (Tb=Tb at T_{c11-min}) (330). In this manner, the engine can be controlled in the OFF state and the first and second torque machines 60, 62 can generate tractive torque responsive to the output torque request while preventing engine rotation in the second direction 59, i.e., preventing engine rotation in the positive direction.

The disclosure has described certain preferred embodiments and modifications thereto. Further modifications and alterations may occur to others upon reading and understanding the specification. Therefore, it is intended that the disclosure not be limited to the particular embodiment(s) disclosed as the best mode contemplated for carrying out this disclosure, but that the disclosure will include all embodiments falling within the scope of the appended claims.

1. A method for controlling a powertrain system including an engine coupled via an input member to a multi-mode transmission configured to transfer torque among the engine, first and second torque machines, and an output member, said input member including a clutch element configured to prevent rotation of the engine in a negative direction, the method comprising:
in response to an output torque request when the engine is in an OFF state:
controlling motor torques from the first and second torque machines responsive to the output torque request including controlling the motor torque from the first torque machine at a positive torque greater than a minimum positive torque and controlling the motor torque from the second torque machine responsive to the output torque request and responsive to the motor torque from the first torque machine.

2. The method of claim 1, wherein controlling the motor torque from the first torque machine responsive to the output torque request comprises controlling motor torque from the first torque machine at the minimum positive torque.

3. The method of claim 1, wherein controlling the motor torque from the first torque machine responsive to the output torque request comprises controlling motor torque from the first torque machine at the minimum positive torque when the output torque request is less than the minimum positive torque.

4. The method of claim 3, wherein controlling the motor torque from the first torque machine at the minimum positive torque comprises controlling the motor torque from the first torque machine to prevent engine rotation in a positive direction.

5. The method of claim 3, wherein controlling the motor torque from the second torque machine responsive to the output torque request and responsive to the motor torque from the first torque machine comprises limiting the motor torque from the second torque machine in response to a maximum charging capacity of a high-voltage battery configured to transfer electric power to the first and second torque machines.

6. The method of claim 1, wherein controlling motor torques from the first and second torque machines responsive to the output torque request comprises controlling the motor torques from the first and second torque machines at optimal torque commands when the output torque request is greater than the minimum positive torque.

7. The method of claim 6, wherein controlling the motor torques from the first and second torque machines at optimal torque commands when the output torque request is greater than the minimum positive torque comprises controlling the motor torque from the first torque machine to prevent engine rotation in the positive direction.

8. The method of claim 1, wherein controlling the motor torques from the first and second torque machines responsive to the output torque request comprises controlling the motor torque from the second torque machine at a maximum torque command associated with a clutch constraint and controlling the motor torque from the first torque machine in response to the output torque request being greater than the maximum torque command associated with the clutch constraint.

9. The method of claim 1, wherein controlling motor torques from the first and second torque machines responsive to the output torque request comprises controlling the motor torque from the first torque machine at a positive torque greater than a minimum positive torque to prevent engine rotation in a positive direction.

10. A method for controlling a powertrain system including an engine and a multi-mode transmission, the method comprising:
controlling the engine in an OFF state; and
controlling motor torques from first and second torque machines responsive to an output torque request including controlling the motor torque from the first torque machine at a positive torque greater than a minimum positive torque and controlling the motor torque from the second torque machine responsive to the output torque request and responsive to the motor torque from the first torque machine.

11. The method of claim 10, wherein controlling the motor torque from the first torque machine responsive to the output torque request comprises controlling motor torque from the first torque machine at the minimum positive torque.

12. The method of claim 10, wherein controlling the motor torque from the first torque machine responsive to the output torque request comprises controlling motor torque from the first torque machine at the minimum positive torque when the output torque request is less than the minimum positive torque.

13. The method of claim 12, wherein controlling the motor torque from the first torque machine at the minimum positive torque comprises controlling the motor torque from the first torque machine to prevent engine rotation in a positive direction.

14. The method of claim 12, wherein controlling the motor torque from the second torque machine responsive to the output torque request and responsive to the motor torque from the first torque machine comprises limiting the motor torque from the second torque machine in response to a maximum charging capacity of a high-voltage battery configured to transfer electric power to the first and second torque machines.

15. The method of claim 10, wherein controlling motor torques from the first and second torque machines responsive to the output torque request comprises controlling the motor torques from the first and second torque machines at optimal torque commands when the output torque request is greater than the minimum positive torque.

16. The method of claim 15, wherein controlling the motor torques from the first and second torque machines at optimal torque commands when the output torque request is greater than the minimum positive torque comprises controlling the motor torque from the first torque machine to prevent engine rotation in the positive direction.

17. The method of claim 10, wherein controlling the motor torques from the first and second torque machines responsive to the output torque request comprises controlling the motor torque from the second torque machine at a maximum torque command associated with a clutch constraint and controlling the motor torque from the first torque machine in response to the output torque request being greater than the maximum torque command associated with the clutch constraint.

18. The method of claim 10, wherein controlling motor torques from the first and second torque machines responsive to the output torque request comprises controlling the motor torque from the first torque machine at a positive torque greater than a minimum positive torque to prevent engine rotation in a positive direction.
